(19) United States
(12) Patent Application Publication
(10) Pub. No.: US 2010/0254745 A1
(43) Pub. Date: Oct. 7, 2010

(54) INK FORMULATION AND WRITING INSTRUMENT

(75) Inventor: Prabhakara S. RAO, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/752,857

(22) Filed: Apr. 1, 2010

Related U.S. Application Data
(60) Provisional application No. 61/165,712, filed on Apr. 1, 2009.

(51) Int. Cl. A46B 5/02; C08L 99/00; C08K 5/3415; C08K 5/10; C08K 5/20; C08K 5/07

(52) U.S. Cl. 401/6; 524/543; 524/104; 524/284; 524/210; 524/361

(57) ABSTRACT

Ink formulation comprising liquid medium and colorant dispersed in the liquid medium wherein the liquid medium comprises an unsaturated resin derived from natural sources. Also, writing instruments containing such ink formulation.

### PRIORITY CLAIM

This application claims priority to U.S. Provisional Patent Application No. 61/165,712, filed Apr. 1, 2009, which is incorporated herein by reference in its entirety.

### FIELD OF INVENTION

The present invention relates to an ink formulation and devices containing such formulation.

### BACKGROUND

Over the years many different variations of pens have been suggested. Examples include fountain pens, ballpoint pens, and rollerball pens.

Fountain pens typically use water-based liquid ink delivered through a nib. The ink flows from a reservoir through a “feed” to the nib, then through the nib, due to capillary action and gravity. The nib has no moving parts and delivers ink through a thin slit to the writing surface. A fountain pen reservoir can be refillable or disposable, this disposable type being an ink cartridge. A pen with a refillable reservoir may have a mechanism, such as a piston, to draw ink from a bottle through the nib, or it may require refilling with an eyedropper. Refillable reservoirs are available for some pens designed to use disposable cartridges.

Ballpoint pens typically dispense viscous oil-based ink by rolling a small hard sphere, usually 0.7 to 1.2 mm in diameter and made of brass, steel or tungsten carbide. The ink dries almost immediately on contact with paper. This type of pen is generally inexpensive and reliable and has replaced the fountain pen as the most popular tool for everyday writing.

Later, rollerball pens were introduced which typically dispense a water-based liquid or gel ink through a ball tip similar to that of a ballpoint pen. The less-viscous ink is more easily absorbed by paper than oil-based ink, and the pen moves more easily across a writing surface. The rollerball pen was initially designed to combine the convenience of a ballpoint pen with the smooth “wet ink” effect of a fountain pen. Gel inks are available in a range of colors, including metallic paint colors and glitter effects.

Gel ink pens have become more popular in recent years. Gel inks typically have higher viscosity than other inks and thus typically support a higher proportion of pigment. As a result such pens exhibit because of the smooth writing feel and brilliant, more vibrant writing colors that they can achieve. Illustrative examples of pigments used in gel inks include copper phthalocyanine and iron oxides. Gel inks are typically made up of water and biopolymers, such as xanthan gum and tragacanth gum, as well as thickeners, e.g., polyacrylate thickeners.

However, the writing produced with such pens is typically subject to smearing and poor resistance to highlighters. Better performing inks, in particular, better performing gel inks are desired.

### SUMMARY OF INVENTION

The present invention provides a novel ink formulation with surprising performance and also provides writing instruments containing such ink. The inks of the invention can be used in a variety of pens. In one embodiment, inks of the invention can be used as gel inks, providing superior performance.

In brief summary, ink compositions of the invention comprise one or more colorants, one or more dispersing agents, and a liquid medium made up of one or more liquids. In accordance with the present invention, the dispersing agent is an unsaturated resin derived from natural sources, e.g., cashew nutshell liquid. Typically ink formulations of the invention are non-aqueous.

We have found that such formulations provide surprising performance as inks. In particular, formulations of the invention can be used to make gel inks that exhibit superior performance. Inks and writing instruments of the invention provide a number of advantages including one or more of good resistance to smearing of written matter, good resistance to exposure to being overwritten by highlighters, good resistance to water wash, pleasing writing action, and good skip resistance.

### DETAILED DESCRIPTION OF ILLUSTRATIVE EMBODIMENTS

As described above, ink compositions of the invention comprise a dispersion of one or more colorants with one or more dispersing agents in a liquid medium made up of one or more liquids.

Colorants for use in ink formulations of the invention comprise those selected from the group consisting of organic pigments and dyes. Typically it is preferred that one or more pigments be used in formulations of the invention. Illustrative examples of pigments useful herein include carbon black, e.g., RAVEN™ 1200 from Columbian Chemicals; COLOUR BLACK™, HI BLACK™, PRINTEXT™, AND PANTHER™ Black Pigments from Degussa Engineered Carbons; Acetylene Blacks; INXEL™ Predispersed Blacks from Evonik; X-FAST™ Black (BASF); and the like. Illustrative examples of blue pigments useful herein include a series of SUNSPERSE™ Pigments, SPECTRAPAC™ (Sun Chemical), HEUCO™ Blue series (Heucotech), X-FAST™ Blue (BASF); and illustrative examples of red pigments include SUNSPERSE™ Red (Sun Chemical) and HEUCO™ Red (Heucotech), X-FAST™ Red (BASF), INXE™ Red (Evonik), IRGAZIN™ RED (CIBA).

Suitable colorants may be readily selected by those skilled in the art based upon the desired application, e.g., fade resistant pigments, vibrant colors, etc. The colorant(s) selected should be compatible with the medium, thus, for example, colorants that are highly hydrophilic may not be suitable for use herein.

It has been discovered that an unsaturated resins derived from cashew nutshell liquid can be used as a dispersing agent to yield inks exhibiting superior performance as described herein. In addition, because such resins are extracted from plants, they are a sustainable component of inks in addition to providing surprising performance. Illustrative examples of resins useful herein includes meta-substituted alkenyl phenols, e.g., a cardanol-based resin, e.g., pentadecenyl-8,11-phenol. Commercially available forms of such material include several CASHEWTHANE™ Resins from Palmer International, Inc., e.g., 1601-75MS 1600-1, 1611-1, 1630-1, 1600-75MS, 1610-75MS, 1611-75MS, and 1612-75MS. While we do not wish to be bound by this theory, it is believed that such phenolic resins are adsorbed to the pigment particles or form intimate physical or chemical contact therewith.

The liquid medium in which the colorant and dispersing agent are dispersed comprises one or more liquids. Illustrative examples of suitable liquids include such hydrocarbon solvents as N-methylpyrrolidone, propyleneglycol methyl acetate, and SOLUSOLVE™ 2075, a low VOC aliphatic (C₂₂H₄₂O₆) from Solutia, Inc. N,N-dimethyl acetamide, 5-methyl-2-hexanone, and ethyl acetate. The liquid medium is preferably compatible with the colorant(s), dispersing agent(s), and other components such that the resultant ink formulation is stable and not subject to phase separation or degradation of the formulation.

In some embodiments, ink formulations of the invention will comprise about 5 to about 30 weight percent solids with the weight ratio of pigment to the alkenyl phenol being from about 1:1 to about 1:5. A suitable ratio for a particular application can be readily determined by selecting quantities that where high shear mixing of the pigment and dispersing agent resin yield a stable dispersion.

Depending upon the characteristics desired, ink formulations of the invention may further comprise one or more optional additives including but not limited to aluminum flakes, glass particles, cosolvents, hardener, film former, corrosion inhibitor, fragrance or scent agents, defoamer, surfactant, etc. The additive(s) selected should be compatible and miscible in the formulation, thus typically the additives selected will be organic-solvent based rather than water-based emulsions or water-soluble.

A typical embodiment of writing instrument of the invention is a ballpoint device though the inks provided herein can be used in other devices if desired. In a typical embodiment of gel pen, the pen comprises a barrel containing the writing mechanism and a cap, and a reservoir filled with the ink. The barrels can be created in many different sizes and designs. The size of the nib or pen tip typically ranges from about 0.18 mm to about 1.5 mm.

To make an ink of the invention, the pigment particles and dispersing agent are thoroughly mixed, e.g., in a grinding operation, to make a flowable slurry as well as to break up any agglomerated particles of undesirable size. Typically, the pigment particles have an average size of less than about 1 micron, and in some embodiments preferably less than about 0.5 micron. The slurry is then mixed with the liquid medium and other additives, if any, to yield the ink formulation of the invention. To make a pen of the invention, the resultant ink formulation is placed in the reservoir of a pen. One of the surprising advantages of the present invention is that ink formulations of the invention are stable and resistant to phase separation. It has been found that addition of co-solvents such as N-methylpyrrolidone, propylene glycol, methyl ether acetate, and N,N-dimethyl acetamide was found to enhance the stability of the inks and to improve the adhesion of the ink to common paper writing surfaces.

When a pen of the invention is used, the ink provides a smooth, pleasing writing feel. In addition the pen generates a thick, consistent line with reduced tendency to skip as compared to previously known gel pens. When used on a paper substrates, the solvent achieves good penetration into paper making the resultant writing stick to the substrate. After the ink dries, it exhibits good resistance to smearing, e.g., when rubbed by hand, and good resistance to fading with overmarked with a highlighter. While we do not wish to be bound by this theory, it is believed that the unsaturated dispersing agent may react with atmospheric oxygen as the ink dries, enhancing the hardness and durability of the writing.

### Examples

The invention will be further explained with the following illustrative inventions. All amounts in parts by weight unless otherwise indicated.

A variety of colorants and additives, as shown in Table 1 and Table 2, respectively, were utilized in preparing the ink formulations of the present invention.

TABLE 1
Colorants

| Code | Pigment | Color | Supplier |
|---|---|---|---|
| A | HEUCO ® 501532 | Blue | Heucotech Ltd., Fairless Hills, PA |
| B | HEUCO ® VYB3GFW 9001 | Blue | Heucotech Ltd. |
| C | HEUCO ® VYB3RFWN | Blue | Heucotech Ltd. |
| D | XFAST ® 7080 | Blue | BASF, Florham Park, NJ |
| E | SPECTRAPAC ™ 15:4 | Blue | Sun Chemical Corporation, Parsippany, NJ |
| F | REGAL ® 400R | Black | Cabot Corporation, Boston, MA |
| G | RAVEN ® 1200 | Black | Columbian Chemicals Company, Marietta, GA |
| H | XFAST ® 0060 | Black | BASF |
| I | XFAST ® 0066 | Black | BASF |
| J | SUNFAST ® 7 | Black | Sun Chemical Corporation |
| K | HEUCO ® 300203 | Red | Heucotech Ltd. |
| L | HEUCO ® 300204 | Red | Heucotech Ltd. |
| M | XFAST ® 3855 | Red | BASF |
| N | QUINDO ® 122 | Magenta | Sun Chemical |
| O | PANTINT ® 5B1236 | Blue | Pan Technology Inc., Carlstadt, NJ |
| P | HEUCO ® VYB 515303 | Blue | Heucotech Ltd. |
| Q | INXEL ™ A501 | Blue | Inxel Trademark & Patents Sagl, Italy |
| R | INXEL ™ A502 | Blue | Inxel Trademark & Patents Sagl |
| S | Monolite ® Blue 515400 | Blue | Heucotech Ltd. |
| T | INXEL ™ A301 | Red | Evonik Corp. |
| U | INXEL ™ A303 | Red | Evonik Corp. |

TABLE 2
Additives

| Code | Additive | Description | Supplier |
|---|---|---|---|
| 1 | LANCO ™ Antimar 430 | Slip agent, 52% dispersion | Lubrizol Corporation, |
| | | of polysiloxane in | Wickliffe, OH |
| | | Xylene/Isobutanol | |
| 2 | LANCO ™ Glidd 5792 | Slip agent, 16% dispersion of | Lubrizol Corporation |
| | | PTFE in isopropanol. | |
| 3 | NANOBYK ® 3650 | Dispersion of surface treated | BYK USA Inc., |
| | | silica nanoparticles | Wallingford, CT |
| 4 | MOLY WHITE ® St#1 | Calcium metaborate/silicate | Moly White Pigment |
| | | corrosion inhibitor | Group, Cleveland, OH |
| 5 | IRCOSPHERE ® 2155 | Succinimide dispersant | Lubrizol Corporation |
| 6 | SILWET ™ 7510 | Non-aqueous silicone | Momentive Performance |
| | | surfactant | Materials, Albany, NY |
| 7 | ZINC TEN-CEM ™ | 18% solution | Mooney Chemical |
| 8 | SOLSPERSE ™ 72700 | Polymeric dispersant, 50% in | Lubrizol Advanced |
| | | ethyl acetate | Materials, Inc., |
| | | | Cleveland, OH |

Ink Preparation

For Examples 1-28 a mixture of 2.5 parts CASHEWTHANE™ 1601-75MS and 1 part SOLUSOLV™ 2075 was prepared. CASHEWTHANE™ 1601-75MS is a mixture of a natural phenolic resin and mineral spirits, while SOLUSOLV™ 2075 is a high boiling ester with low volatile organic content. The pigments and additives for each ink example were added to 50 grams of this solvent mixture, unless otherwise noted.

A variety of inks were prepared using the ingredients shown in Tables 1 and 2 as indicated in Table 3.

Example 1, a blue ink, was prepared by adding 3.5 grams of HEUCO® 501532 blue to 50 grams of liquid medium. The composition was mixed until a homogenous dispersion was obtained. The mixture was then ground for 24 to 48 hours in a ball mill containing approximately 120 grams of 1.5 mm yttrium-hardened zironia beads. The ground mixture was passed through a screen mesh to isolate the ink.

The inks in Examples 2 to 28 were prepared with the same process outlined for Example 1. As noted in Table 3, examples 7, 8, 13, and 14 required additional SOLUSOLV® after the grinding process to thin the compositions. No particular order of addition was required for Examples 18 to 28. All inks of Table 3 exhibited excellent writeability.

TABLE 3
Inks - Examples 1-28

| | Pigment(s) | Additive (grams) | | | | |
|---|---|---|---|---|---|---|
| Example | (grams) | 1 | 2 | 3 | 4 | 5 |
| 1 | A (3.5) | —[a] | — | — | — | — |
| 2 | A (4.5) | — | — | — | — | — |
| | I (0.5) | | | | | |
| 3 | B (5.0) | — | — | — | — | — |
| 4 | I (5.0) | — | — | — | — | — |
| 5 | H (4.0) | — | — | — | — | — |
| 6 | C (5.0) | — | — | — | — | — |
| 7[b] | K (4.5) | — | — | — | — | — |
| 8[b] | L (4.5) | — | — | — | — | — |
| 9 | I (4.5) | — | — | — | — | — |
| 10 | F (4.5) | — | — | — | — | — |
| 11 | G (4.5) | — | — | — | — | — |
| 12 | D (5.0) | — | — | — | — | — |
| 13[c] | M (4.5) | — | — | — | — | — |
| 14[c] | N (4.5) | — | — | — | — | — |
| 15 | E (4.5) | — | — | — | — | — |
| | J (0.5) | | | | | |
| 16 | J (5.0) | — | — | — | — | — |
| 17 | E (4.5) | — | — | — | — | — |
| | G (0.5) | | | | | |
| 18 | E (4.0) | — | — | — | — | 1.0 |
| | G (0.7) | | | | | |
| 19 | G (4.0) | — | — | — | — | 1.0 |
| 20 | G (4.5) | 0.5 | 0.5 | 0.2 | 0.2 | — |
| 21 | E (4.5) | 0.5 | 0.5 | — | 0.2 | — |
| | G (0.5) | | | | | |
| | O (0.5) | | | | | |
| 22 | L (4.5) | 0.5 | 0.5 | 0.2 | 0.2 | — |
| 23 | G (5.5) | 0.5 | 0.5 | 0.2 | 0.2 | — |
| 24 | G (4.5) | 0.5 | 0.5 | 0.2 | 0.2 | — |
| | J (1.0) | | | | | |
| 25 | E (5.0) | 0.5 | 0.5 | 0.2 | 0.2 | — |
| | G (0.2) | | | | | |
| | O (1.0) | | | | | |
| 26 | D (6.0) | 0.5 | 0.5 | 0.2 | 0.2 | — |
| | O (1.0) | | | | | |
| 27 | K (4.5) | 0.5 | 0.5 | 0.2 | 0.2 | — |
| 28 | P (4.5) | 0.5 | 0.5 | 0.2 | 0.2 | |

[a]none added
[b]~17 g SOLUSOLV ™ 2075 was added after initial mixing to thin the ink
[c]~10 g SOLUSOLV ™ 2075 was added after initial mixing to thin the ink

For Examples 29-40, ink masterstocks were prepared as indicated in Table 4, using in each case 99.8 grams of CASHEWTHANE™ 1612-75MS.

TABLE 4
Ink Masterstocks

| | Masterstock | | | |
|---|---|---|---|---|
| Component (grams) | M1 | M2 | M3 | M4 |
| PM Acetate | 6.5 | 10.4 | 6.5 | 6.5 |
| N-methyl-2-pyrrolidone | 6.5 | 10.4 | 10.4 | 10.4 |
| 6 | 2.5 | 2.5 | 2.5 | 2.5 |
| Silica nanoparticles | 1.25 | 1.25 | 1.25 | 1.25 |
| 7 | 0.9 | 0.9 | 0.9 | 0.9 |
| 8 | 6.5 | 6.5 | 3.9 | 9.6 |
| Pigment | G (13) | Q (9.75) | S (20) | T (20) |
| | | R (13) | | U(20) |

TABLE 5
Inks - Examples 29-40

| | Ink Masterstock | Added Solvent(s) |
|---|---|---|
| Example | (grams) | (grams) |
| 29 | M1 (40) | PM acetate (2.5) |
| | | N-methyl-2-pyrrolidone (2.5) |
| 30 | M! (40) | N,N-dimethyl acetamide (2.5) |
| | | Propyleneglycol methylether |
| | | acetate (2.5) |
| 31 | M1 (40) | SOLUSOLV ™ 2075 (8) |
| 32 | M1 (40) | SOLUSOLV ™ 2075 (10) |
| 33 | M1 (10) | LANCO ATMAR 430* (from |
| | | Lubrizol) (10) |
| 34 | M2 | None |
| 35 | M3 (40) | SOLUSOLV ™ 2075 (10) |
| 36 | M3 (40) | LANCO ATMAR 430 (10) |
| 37 | M4 (40) | N-methyl-2-pyrrolidone (3) |
| | | Propyleneglycol methylether |
| | | acetate (3) |
| 38 | M4 (40) | Propyleneglycol methylether |
| | | acetate (3) |
| | | N,N-dimethyl acetamide (3) |
| 39 | M4 (40) | SOLUSOLV ™ 2075 (10) |
| 40 | M4 (40) | LANCO ATMAR 430 (10) |

*Contains polyether, xylene, polydimethylsiloxane, isobutyl alcohol and ethyl benzene

Each of inks was filled in cartridges fitted with 0.7 mm tips and 0.5 mm tips.

The best results obtained for writing with 0.5 mm tips on plain bond paper showed smear resistance and highlighter resistance for black, blue and red inks after about 5 to 10 seconds of drying. For 0.7 mm tips, that produced thicker lines the drying time was about to about 10 sec. for smear resistance and about 10 to about 15 sec. for highlighter resistance. Smear resistance was measured by rubbing the writing with a dry sponge at various intervals of time. Highlighter resistance was measured by running a highlighter on the writing at different intervals of time. The writing should remain stable without smear.

Although the present invention has been fully described in connection with the preferred embodiments thereof, it is to be noted that various changes and modifications are apparent to those skilled in the art. Such changes and modifications are to be understood as included within the scope of the present invention as defined by the appended claims unless they depart therefrom.

What is claimed:

1. An ink composition comprising a colorant, a dispersing agent, and a liquid medium wherein said dispersing agent is an unsaturated resin derived from cashew nutshell liquid.

2. The ink composition of claim 1 wherein said dispersing agent comprises the polymer of a meta-substituted alkenyl phenol with about 3 to 5% of unpolymerized polymer.

3. The ink composition of claim 2 wherein said dispersing agent comprises a cardanol-based resin.

4. The ink composition of claim 1 wherein said dispersing agent comprises pentadecenyl-8,11-phenol.

5. The ink composition of claim 1 wherein said colorant is selected from the group consisting of pigments and dyes.

6. The ink composition of claim 1 wherein said liquid medium is a hydrocarbon solvent.

7. The ink composition of claim 1 wherein said liquid medium is selected from the group consisting of N-methylpyrrolidone, propyleneglycol methyl acetate, C₂₂H₄₂O₆, N,N-dimethyl acetamide, 5-methyl-2-hexanone, and ethyl acetate.

8. The ink composition of claim 1 wherein the weight ratio of said colorant to said dispersing agent is from about 1:1 to about 1:5.

9. The ink composition of claim 1 wherein said colorant is a pigment and said composition comprises between about 5 and about 25 weight percent of said colorant.

10. The ink composition of claim 1 further comprising at least one additive selected from the group consisting essentially of solvent, hardener, film former, corrosion inhibitor, and fragrance or scent agent.

11. A writing instrument containing the ink composition of claim 1.

12. The writing instrument of claim 11 wherein said writing instrument is a gel pen.
